(19) United States
(12) Patent Application Publication
(10) Pub. No.: US 2019/0194978 A1
(43) Pub. Date: Jun. 27, 2019

(54) Locking Apparatus

(71) Applicant: Lantrn Limited, Sheung Wan (HK)

(72) Inventor: Aaron Cooper, Sheung Wan (HK)

(21) Appl. No.: 16/304,531

(22) PCT Filed: May 26, 2017
(86) PCT No.: PCT/IB17/53101

§ 371 Date: Nov. 26, 2018

(30) Foreign Application Priority Data
May 26, 2016 (HK) 16106033.8

(51) Int. Cl. E05B 65/52; E05B 37/02; E05B 37/00; E05B 39/00

(52) U.S. Cl. CPC E05B 65/5246; E05B 39/00; E05B 37/0034; E05B 37/02

(57) ABSTRACT

A locking apparatus (3) for securing a luggage article (1) comprises a mechanism for unlocking the locking apparatus (3) including at least one moveable member (11, 12, 13) which is moveable in an unlocking operation. The locking apparatus (3) has at least one detector arrangement (42, 49, 55a, 55b) associated with at least one moveable member (11, 12, 13) by at least one linkage (19, 37a, 37b, 41) between the detector arrangement (42, 49, 55a, 55b) and the moveable member (11, 12, 13), the linkage (19, 37a, 37b, 41) triggers the detector arrangement (42, 49, 55a, 55b) upon the movement of the moveable member (11, 12, 13).

### FIELD OF THE INVENTION

The present invention relates to locking apparatus.

### BACKGROUND OF THE INVENTION

Personal property, particularly valuable and important property, is commonly stored or transported in secure containers. Such containers are typically secured by locking apparatus that prevents or restricts unauthorised third parties from gaining entry to the containers. Examples of secured containers include safes, houses, cars, shipping containers and luggage. In the case of luggage, locking apparatus is used by passengers to secure luggage during transit to prevent unauthorised access to the personal property contained within the luggage.

A key concern for passengers during transit is, therefore, luggage security. Passengers are often required to part with their luggage and, in so doing, have limited control of who may gain access to their luggage. For example, when an airline passenger wishes to place an item of luggage in the aircraft hold, the passenger must hand the luggage over to the airport security so that the luggage can be screened and transported to the hold. An airline passenger, therefore, no longer has any control over who may access their luggage and places a great deal of trust in airport staff.

Another example is when a passenger is on a train or a coach and must store their luggage in a location remote from their seat which is out of sight. In such circumstances, the passenger must trust that members of the general public will not attempt to gain access to the luggage and steal items therefrom or put items therein. Unfortunately, members of luggage handling staff and the general public can sometimes attempt to gain entry to secured luggage articles in order to steal personal property or include items in the luggage article for illicit purposes. Whilst most modern day luggage comprise locking apparatus to prevent unauthorised access, sometimes the locking apparatus can be bypassed either by force or some other mode of access.

One mode of access has resulted from heightened levels of security across transportation hubs, such as airports, and this has led to the development of “master keys” which enable master key holders to gain access to luggage articles equipped with master key compatible locking apparatus. These keys have been designed to provide baggage-handling officials with the ability to override approved luggage-locking mechanisms in order to easily access the contents of baggage for inspection. In the United States of America, for example, it is a requirement that the Transportation Security Administration (TSA), which screens passenger's luggage before it is placed on an airplane, has access to luggage without the passenger being present. As a consequence of this, the TSA has worked with several companies, including Travel Sentry, to develop locks that can be opened by airport security personnel using such master keys so that the locks do not have to be cut or pried open. Although these keys are intended for official use, abuse of power and ease of access to these keys allows for unauthorised access to the contents of luggage articles without leaving any evidence of opening the bag.

Suitcases, and other forms of luggage, are also extremely vulnerable to pilferage and tampering without detection. This is primarily a result of current securing means such as zippers and padlocks or built-in luggage locks being too easily bypassed through the use of everyday tools and particular know how. For example, ballpoint pens or other foreign objects can be used to easily pry open the binding zipper edge of a suitcase with a padlock attached and resealed by simply moving the padlocked zips back around the suitcase.

In a further example, everyday foreign objects such as name cards, lock picks and screw drivers can be used to bypass locks or pry open the locked zips placed within built-in luggage locks and gain unauthorised access to the contents of a luggage article. Although some of these methods may be detectable by the owner upon being reunited with the given luggage article, it may not be obvious at first glance.

Therefore, there are several instances during transit in which an unauthorised individual may gain, or at least attempt to gain, access to a passenger's luggage without the passenger being present. The aforementioned vulnerabilities also make it extremely difficult for luggage users to resolve any baggage pilferage or tampering situation and prevent unauthorised third party items being put into luggage articles before it is too late and are typically left without reliable proof that such events even occurred.

Particularly for air travel, it is important that a passenger can identify when their luggage has been accessed and when an item may have been stolen or inserted into their luggage. Identifying a more precise period of time in which luggage may have been stolen or tampered with can help to identify who handled the luggage and, therefore, narrow down the list of possible suspects. Quickly identifying a luggage breach and/or theft and/or tampering event can therefore help to safeguard a passenger's rights and enable intervening action to be taken.

Independent travel based padlocks, luggage wraps and built-in luggage locks have typically been used to secure luggage articles and protect the personal contents placed inside from unauthorised access. Padlocks, for example, typically comprise cylinder locks or combination locks and are designed to prevent access to the contents of luggage by clasping the openings of two zips together to prevent their separation. Luggage wraps are designed to protect luggage articles from damage and theft. The luggage is wrapped in multiple layers of saran like plastic making it more difficult to access the contents of luggage without detection. Some luggage comprises built-in luggage locks which are integrated into luggage articles during the manufacturing process as a permanent feature. For luggage that has a binding zipper edge, the locks are designed to bolt the zips in a fixed position, preventing the luggage from being opened by separating the zips. For luggage that is not bound with a zipper, the built in locks are design to clasp the edges of a suitcase together at a particular point.

More recently, the traditional luggage lock types mentioned above have begun to evolve with added technological elements such as remote unlocking via smartphone and proximity sensing between the lock and smartphone.

Despite the technological evolution of locking apparatus, there is still no effective method for determining how and when luggage has been opened and/or tampered with during moments of separation between the luggage and the owner.

In the case of padlocks, considering the zips can still be moved to reclose the binding edge of a tampered zipper, pad locks do not prevent a luggage article from being accessed without detection (i.e. a zipper that has been pried open with a ballpoint pen or another foreign object).

Luggage wraps or externally attached security measures could be damaged and/or removed as a result of going through the violent nature of the baggage journey. Therefore, there is no reliable way to determine whether unauthorised persons accessed the contents of luggage when luggage wraps are used.

Even if travel based locking apparatus have the ability to detect unauthorised entry, mechanical methods of detections are typically difficult to notice, with other methods being unable to determine the difference between an unauthorised or authorised opening (i.e. tampering event vs. a TSA agent using a master key vs. correct combination) or indicate when the opening/tampering event occurred.

In view of the above, there is a need for a tamper evident locking apparatus that can notify the owner of a luggage article of an unauthorised access or attempt at unauthorised access and when this occurred.

It is, therefore, an object of the present invention to provide an improved locking apparatus capable of detecting, and notifying a user of, unlocking or attempted unlocking of the locking apparatus.

### SUMMARY OF THE INVENTION

In accordance with a first aspect of the present invention, there is provided a locking apparatus for securing a luggage article comprising:

a mechanism for unlocking the locking apparatus including at least one moveable member moveable in an unlocking operation, and

at least one detector arrangement associated with at least one moveable member by at least one linkage between the detector arrangement and the moveable member such that at least one linkage triggers the detector arrangement upon movement of the moveable member.

Advantageously, one or more linkages between a moveable member of an unlocking mechanism and a detector arrangement enables the detector arrangement to be retrofit onto an existing unlocking mechanism of a locking apparatus through engagement with one or more linkages. One or more linkages also enables the unlocking mechanism and the detector arrangement to be manufactured separately and connected at a later stage via the one or more linkages. Thus, the cost and complexity of assembly of a locking apparatus according to the invention may be reduced. Furthermore, one or more linkages can be used to amplify movement of one or more moveable members so that different types of movements by the moveable members may be distinguished from one another. This enables different types of unlocking or attempted unlocking events to be identified.

At least part of at least one linkage may replicate movement of the moveable member. At least part of at least one linkage may move with the moveable member.

The locking apparatus may comprise a plurality of moveable members and a plurality of detector arrangements, each detector arrangement associated with at least one moveable member by at least one linkage.

At least one linkage may mechanically connect a detector arrangement and a moveable member. At least one linkage may be integrally formed with at least one moveable member. At least one linkage may be one or more electromagnetic waves.

A first moveable member may be rotatable by a key and rotation of the first moveable member may rotate at least one linkage to trigger at least one detector arrangement.

A second moveable member may be moveable by the first moveable member for unlocking the locking apparatus, and at least one linkage may move with the second moveable member to trigger at least one detector arrangement.

The locking apparatus may further comprise a combination lock restricting movement of the first moveable member in an engaged state and permitting movement of the first moveable member in a disengaged state.

At least one moveable member may comprise a retention part operable between a closed state and an open state, wherein in the closed state an external object may be retained by the retention part relative to the locking apparatus and in the open state an external object is releasable from the locking apparatus. The retention part may comprise one or more hooks. The retention part may comprise one or more latches. A linkage may extend between at least part of the retention part and at least one detector arrangement such that movement of at least part of the retention part moves the at least one linkage to trigger the detector arrangement.

At least one detector arrangement may comprise one or more gears arranged to amplify movement of one or more moveable members. At least one detector arrangement may comprise one or more switches actuable by one or more linkages.

In accordance with a second aspect of the present invention, there is provided a luggage article comprising a locking apparatus according to the first aspect.

In accordance with a third aspect of the present invention, there is provided a detecting part of a locking apparatus comprising one or more detector arrangements configured to monitor movement one or more moveable members of an unlocking mechanism of a locking part of the locking apparatus between a locked state and an unlocked state of the locking apparatus.

The detecting part may be engageable with one or more linkages extending from the locking part.

At least one detector arrangement may comprise a gear train driven by movement of one or more of the moveable members of the locking apparatus to amplify movement of the one or more moveable members.

At least one detector arrangement may comprise a switch actuated by movement of one or more of the moveable members of the locking apparatus.

In accordance with a fourth aspect of the present invention, there is provided a locking part of a locking apparatus, the locking part comprising:

an unlocking mechanism comprising at least one moveable member moveable in an unlocking operation,

at least one linkage moveable with at least one moveable member,

wherein at least one linkage is engageable with one or more detector arrangements for detecting movement of one or more moveable members.

In accordance with a fifth aspect of the present invention, there is provided a method of assembling a locking apparatus comprising the steps of connecting a detecting part according to the third aspect to a locking part according to a fourth aspect for monitoring one or more moveable members of the locking part by one or more detector arrangements of the detecting part.

In accordance with a sixth aspect of the present invention, there is provided a linkage operable by one or more moveable members of an unlocking mechanism of a locking apparatus to link a moveable member of the unlocking mechanism to a detector arrangement of a detecting part of the locking apparatus.

In accordance with a seventh aspect of the present invention, there is provided a locking apparatus for securing a luggage article, the locking apparatus operable to transmit one or more wireless signals and having a plurality of operational states including a non-transmitting state and a transmitting state, wherein the locking apparatus determines the operational state based upon a signal transmitted by an aircraft.

The signal transmitted by the aircraft may be an automatic dependent surveillance-broadcast signal. The locking apparatus may be configured to store information from the received signal.

### BRIEF DESCRIPTION OF THE DRAWINGS

Preferred embodiments of the present invention will be explained in further detail below by way of examples and with reference to the accompanying drawings, in which:—

FIG. 1 shows a schematic representation of a luggage article comprising a locking apparatus according to the present invention;

FIG. 2 shows a schematic representation of internal parts of the locking apparatus shown in FIG. 1;

FIG. 3a shows a front perspective view of the locking apparatus shown in FIG. 1;

FIG. 3b shows a rear perspective view of the locking apparatus shown in FIG. 1;

FIG. 4 shows a schematic representation of the locking part shown in FIG. 2 including extensions;

FIG. 5 shows an underside perspective view of a locking part of the locking apparatus shown in FIG. 2;

FIG. 6 shows an underside view of a locking element of the locking apparatus shown in FIG. 2;

FIG. 7 shows a cross section perspective view of the locking apparatus shown in

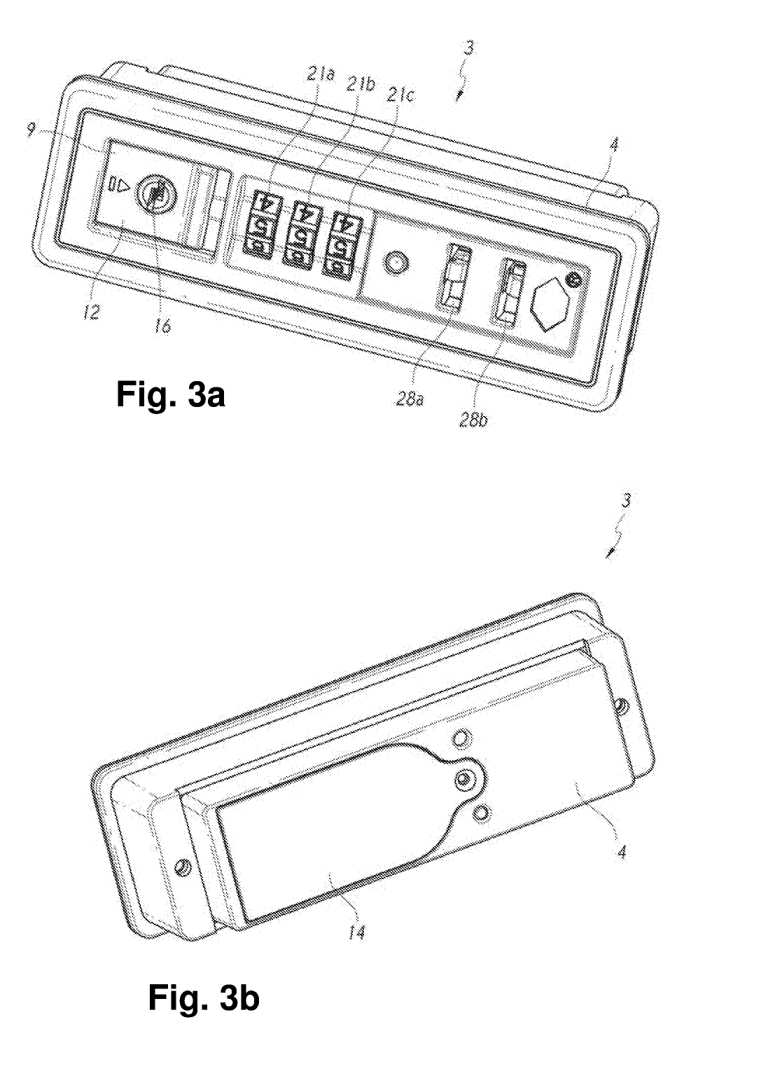

FIGS. 3a and 3b;

FIG. 8 shows internal components of the locking apparatus shown in FIG. 3a;

FIG. 9 shows the internal components of FIG. 8 with the housing of part of the components removed;

FIG. 10 shows parts of the internal components shown in FIG. 8;

FIG. 11 shows an underside perspective view of part of a retaining part shown in FIG. 8;

FIG. 12 shows an underside perspective view of parts of a retaining part shown in FIG. 8;

FIG. 13 shows a perspective view of one of the parts shown in FIG. 12;

FIG. 14 shows a top plan view of the parts shown in FIG. 12;

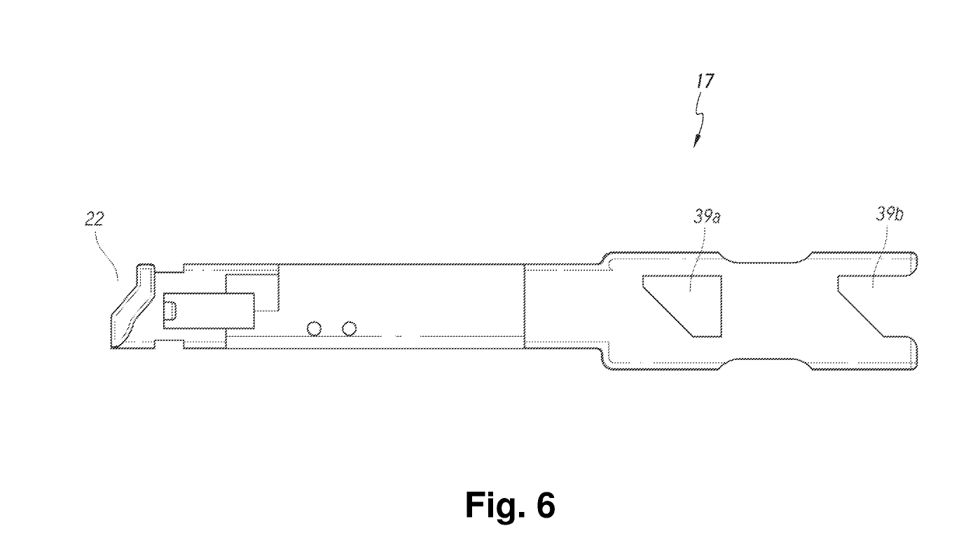

FIG. 15 shows an underside perspective view of the locking element shown in FIG. 6 including an extension part;

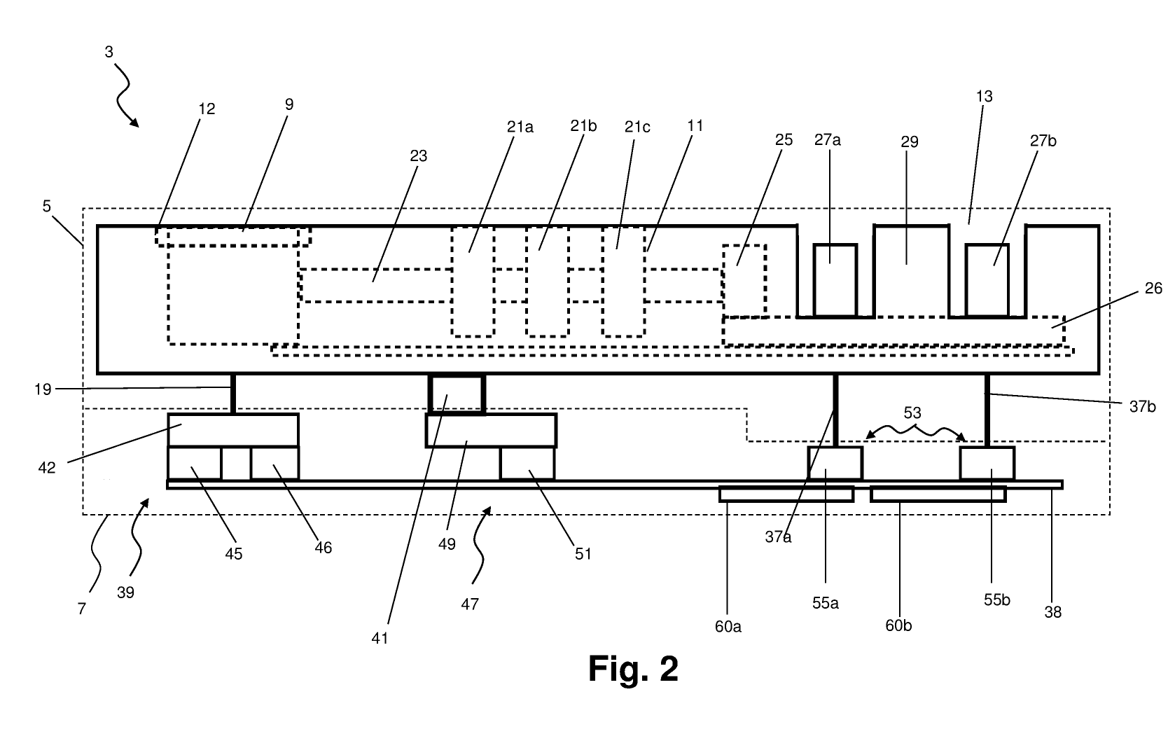

FIG. 16 shows a schematic side view of a detecting part of the apparatus shown in FIG. 2;

FIG. 17 shows a schematic plan view of electronic components of the locking apparatus shown in FIG. 2;

FIG. 18 shows a perspective view of internal parts of the locking apparatus shown in FIG. 2 in operation;

FIG. 19 shows an enlarged perspective view of a part of the internal parts shown in FIG. 18 in operation;

FIG. 20 shows a perspective view of the internal parts shown in FIG. 18 when in a different state of operation;

FIG. 21a shows a flow diagram of operation of the locking apparatus shown in FIG. 2 upon detection of a trigger event;

FIG. 21b shows a flow diagram of operation of the locking apparatus shown in FIG. 2 in different status conditions;

FIG. 22 shows a movement pattern of locking parts of the locking apparatus shown in FIG. 2;

FIG. 23 shows an alternative movement pattern of a locking element of the locking apparatus shown in FIG. 2;

FIG. 24 shows an alternative movement pattern of the parts shown in FIG. 22;

FIG. 25 shows an alternative movement pattern of the parts shown in FIG. 22; and

FIG. 26 shows an alternative movement pattern of the parts shown in FIG. 22.

### DETAILED DESCRIPTION OF THE PREFERRED EMBODIMENTS

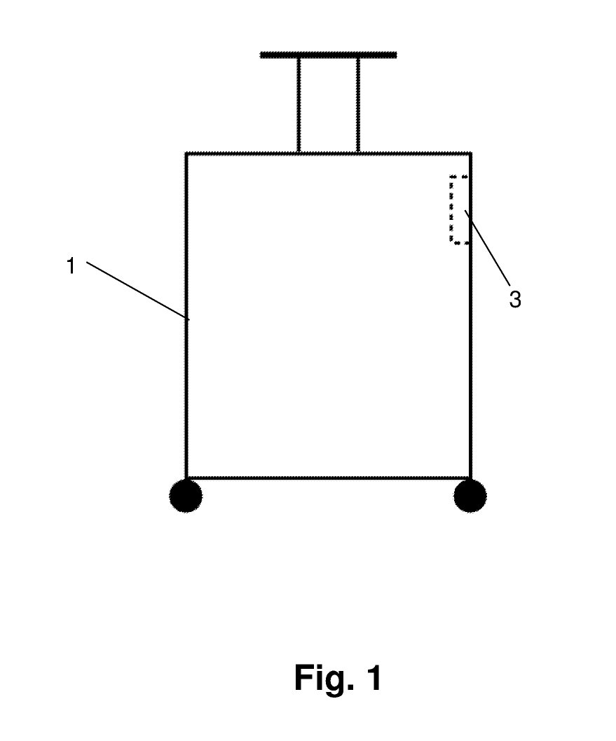

Referring to FIG. 1 there is a shown a luggage article 1 comprising an integrated locking apparatus 3. A schematic representation of internal components of the locking apparatus 3 is shown in more detail in FIG. 2. The tamper evident locking apparatus 3 comprises a locking part 5 and a detecting part 7 which cooperate to identify when and how a tampering event or unauthorised access event occurred.

With reference to FIG. 2, the locking part 5 comprises mechanism for locking and unlocking the locking apparatus 3 including a pin tumbler lock 9, a combination lock 11 and a zip retention means 13. The pin tumbler lock 9 and the combination lock 11 are operable to permit or restrict movement of the zip retention means 13 to retain or release a pair of zippers (not shown) engaged with the zip retention means 13. The pin tumbler lock 9 is linearly movable in a direction toward the zip retention means 13 when the combination lock 11 or the pin tumbler lock 9 are in an unlocked state. The pin tumbler lock 9 comprises a push button 12 to facilitate movement of the pin tumbler lock 9 toward the zip retention means 13.

With reference to FIGS. 3a and 3b, the locking apparatus 3 comprises a housing 4 made from plastics material which contains the locking part 5 and the detecting part 7. The pin tumbler lock 9, combination lock 11 and zip retention means 13 are accessible from an externally facing sidewall of the housing 4 so that the pin tumbler lock 9, combination lock 11 and zip retention means 13 can be accessed by a user from outside the luggage article 1 in which the locking apparatus 3 is incorporated. An internally facing sidewall of the housing 4 comprises a detachable part or door 14 which permits access to inside the housing 4 via the inside of the luggage article 1 so that one or more batteries which may power the locking apparatus 3 may be replaced. It is envisaged that rubber O-rings or other suitable sealing elements be used at regions of the housing 4 having joins or openings to restrict ingress of water into the housing 4.

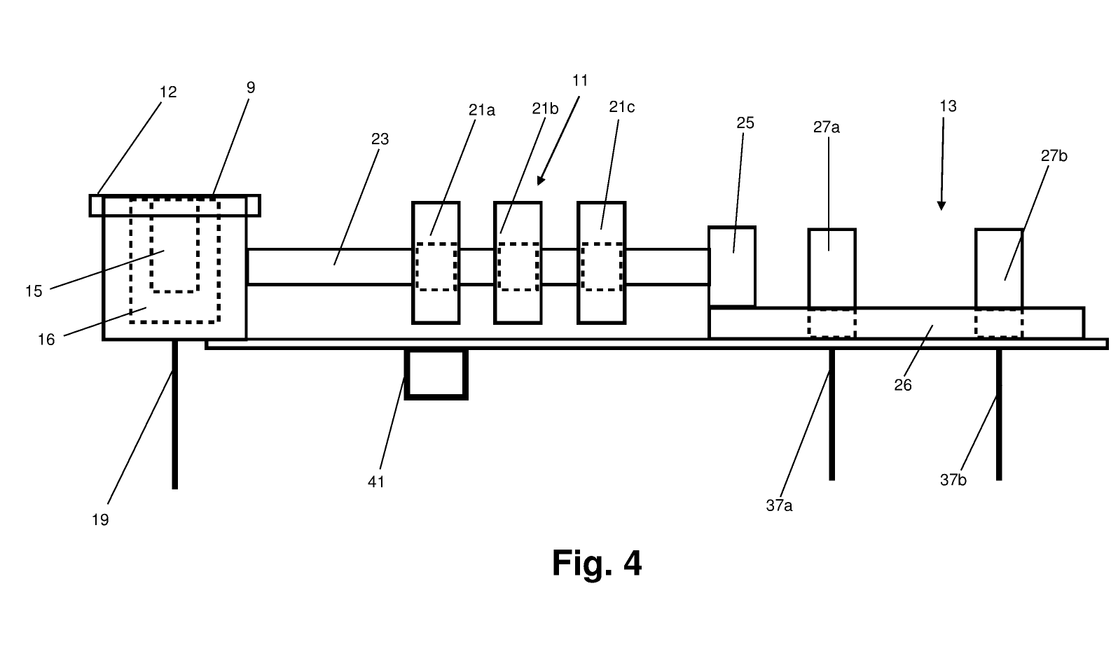

With reference to the drawings and, in particular, FIG. 4, the combination lock 11 comprises three coaxially aligned, numbered combination wheels 21a, 21b, 21c, an axle 23 which extends through each of the combination wheels 21a, 21b, 21c and a combination reset device 25. The axle 23 is arranged between the pin tumbler lock 9 and zip retention means 13. The axle 23 is linearly moveable in a direction toward the zip retention means 13 when the combination wheels 21, 21b, 21c are in an unlocked configuration. When the combination wheels 21a, 21b, 21c are in a locked configuration, linear movement of the axle 23 relative to the wheels is restricted. Thus, when the combination lock 11 is in a locked configuration movement of the axle 23 and, hence, pin tumbler lock 9 in a direction toward the zip retention means 13 is prevented. When the combination lock is in an unlocked configuration, movement of the axle 23 and, hence, pin tumbler lock 9 in a direction toward the zip retention means 13 is permitted. The axle 23 and pin tumbler lock 9 are spring biased away from the zip retention means 13.

Whilst the locking apparatus 3 of the present embodiment comprises a mechanical combination lock 11, it is envisaged the combination lock 11 could be replaced by other suitable locking means such as an electronic password lock that runs off an access code software system that is actuated remotely via a smartphone with appropriate software applications.

The pin tumbler lock 9 is operable between locked and unlocked states and comprises a key cylinder 15 having a keyway 16 for receipt of an appropriately shaped key for actuation of the pin tumbler lock 9 between locked and unlocked states. The pin tumbler lock 9 is connected to the zip retention means 13 by a sliding plate or actuator 17 which extends from the pin tumbler lock 9 and engages with the zip retention mean 13. A rod extension 19 is attached to the pin tumbler lock 9 such that rotation of the key cylinder 15 causes rotation of the rod extension 19. The rod 19 extends from the back of the pin tumbler lock 9 in a direction which is substantially parallel to the axis of the pin tumbler lock 9.

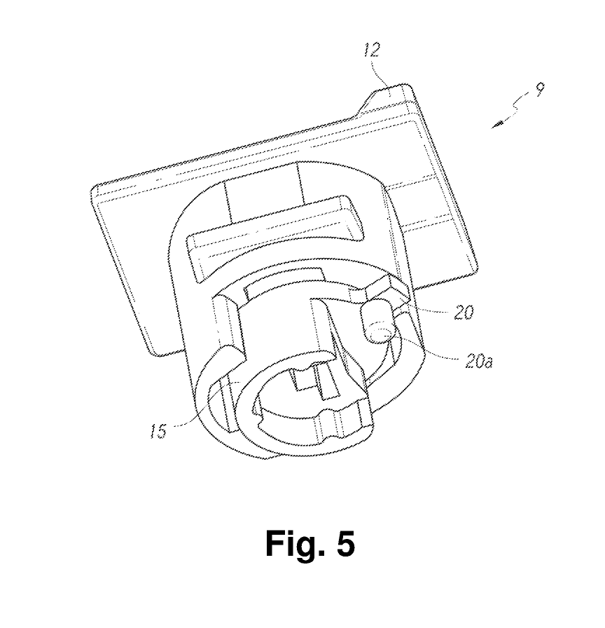

Referring to FIGS. 5 and 6, the pin tumbler lock 9 comprises a swing arm or cam 20 which rotates with the key cylinder 15 upon turning by a key. The cam 20 comprises a short stud 20a which interfaces with a ramped end wall 22 of the sliding plate 17. The ramped end wall 22 is arranged relative to the cam 20 such that rotation of the cam 20 by turning of a key urges the sliding plate 17 in a direction toward the zip retention means by virtue of the stud 20a acting on the ramped surface 22 of the sliding plate 17. Thus, the pin tumbler lock 9 and sliding plate 17 are operable such that unlocking of the pin tumbler lock 9 by a key actuates the zip retention means 13 independently of the combination lock 11 and changes the zip retention means 13 from a locked state to an unlocked state.

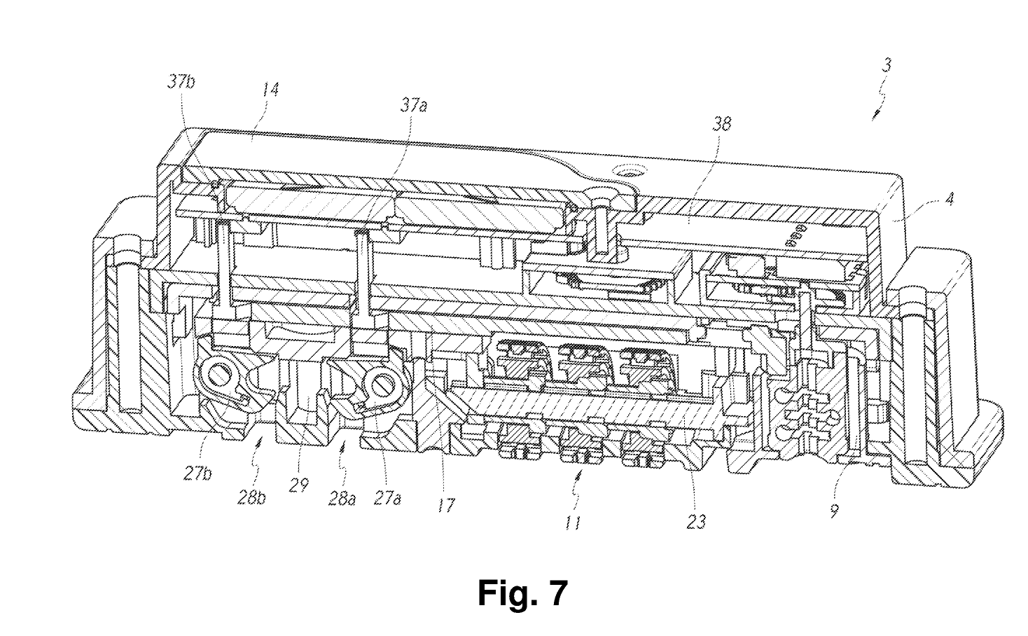

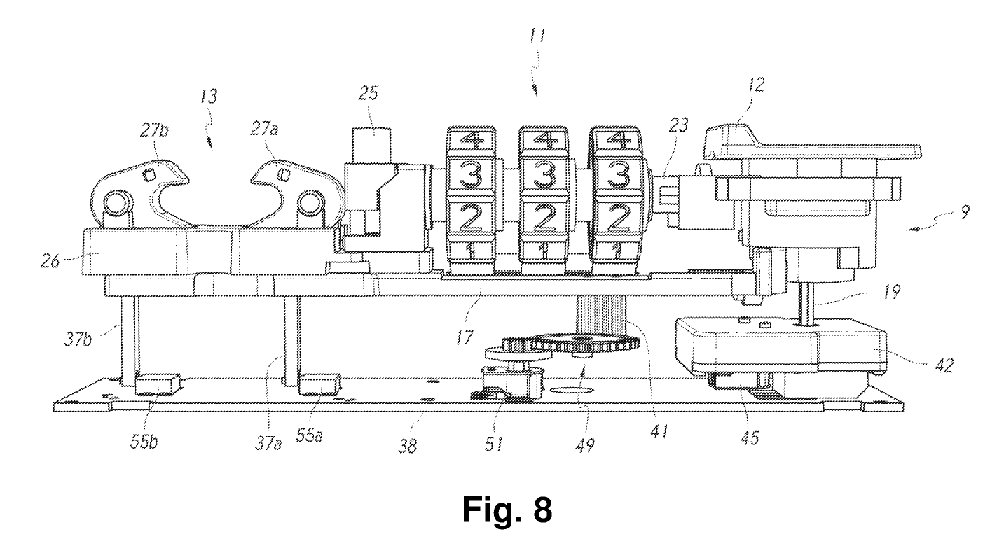

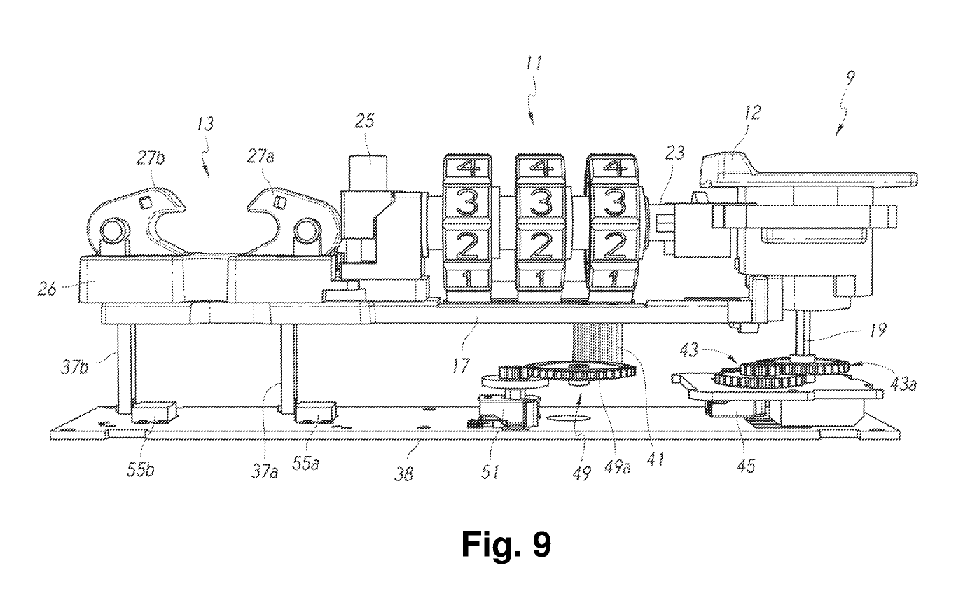

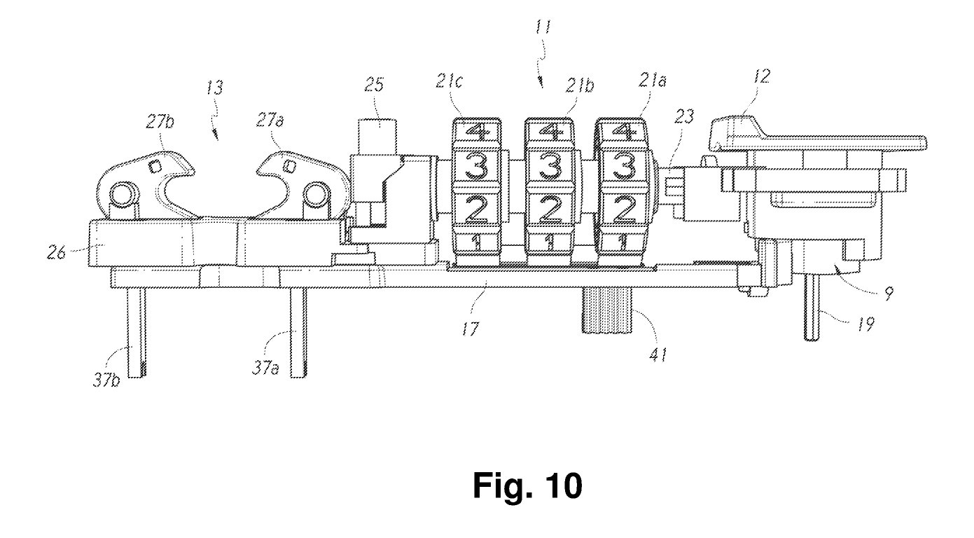

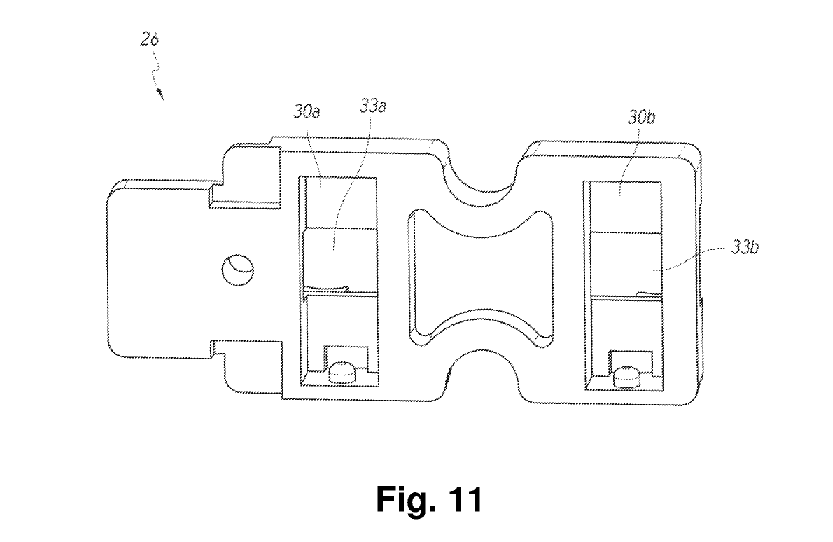

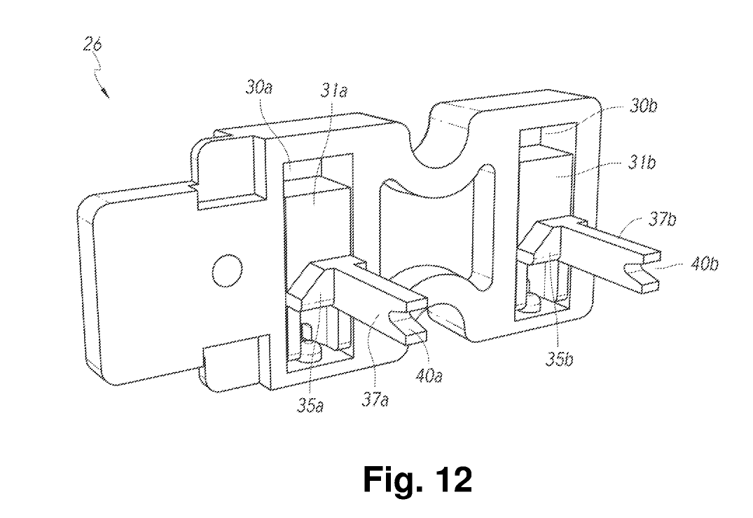

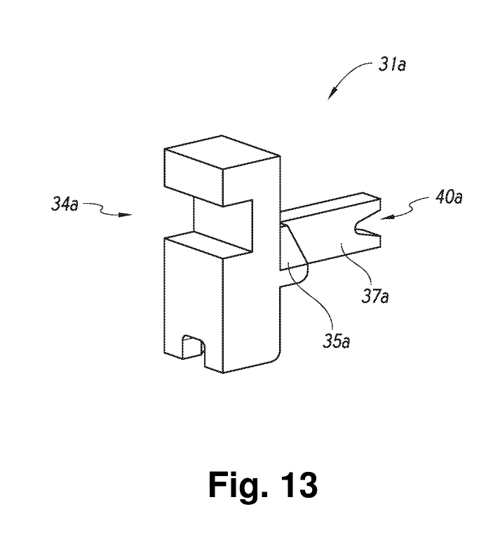

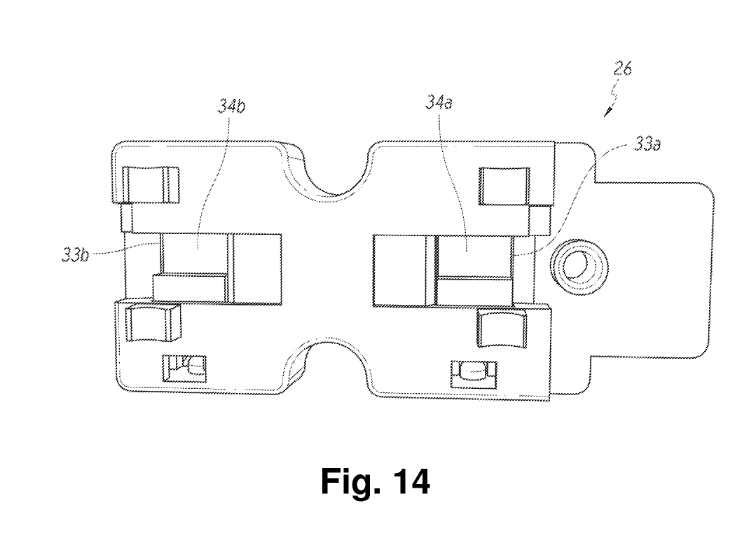

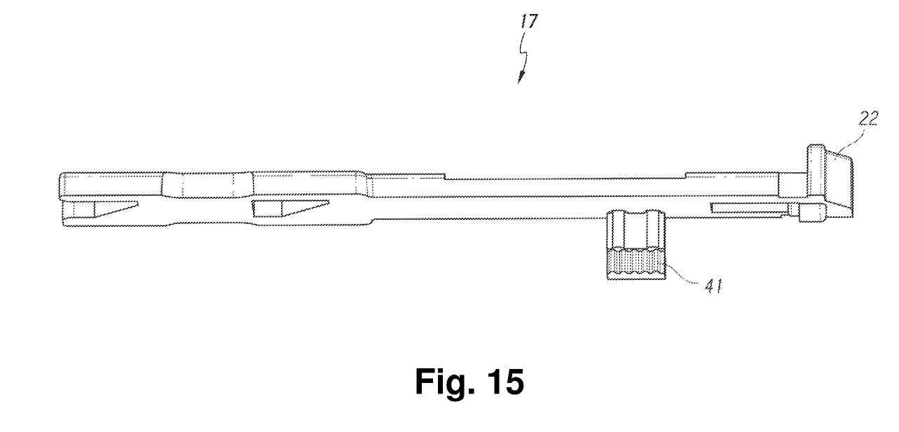

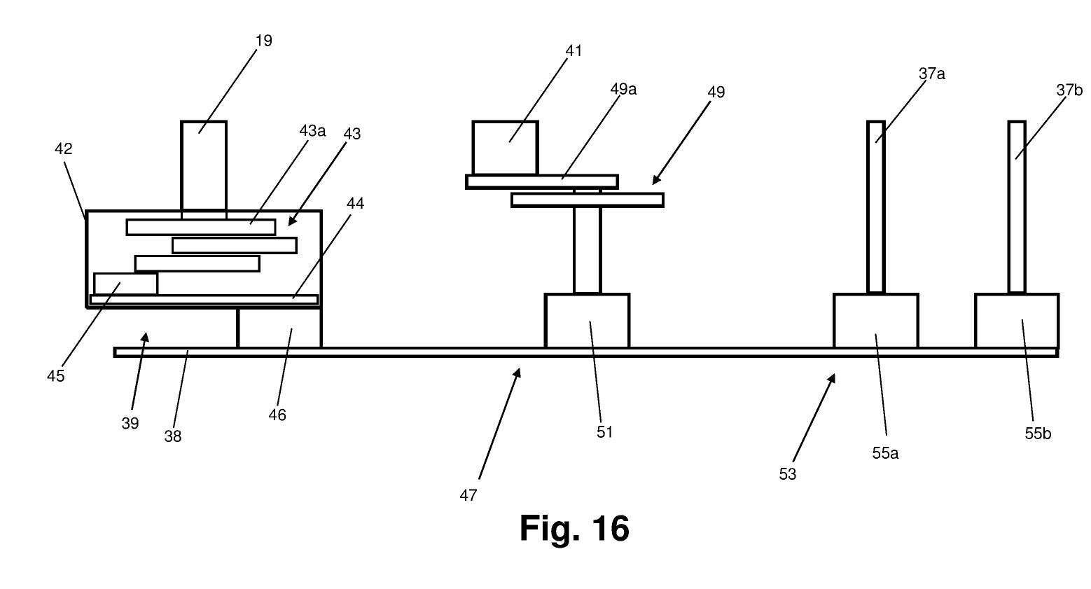

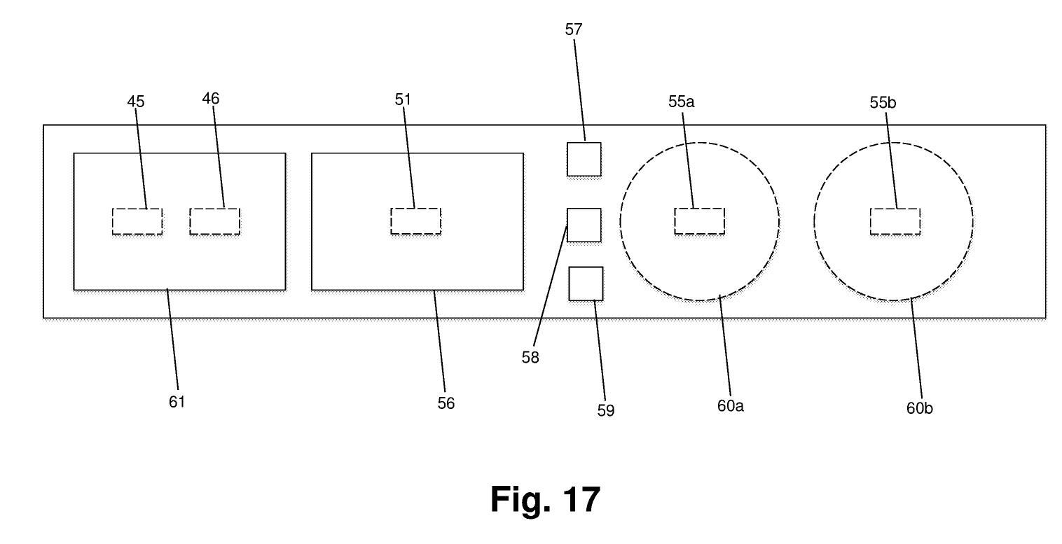

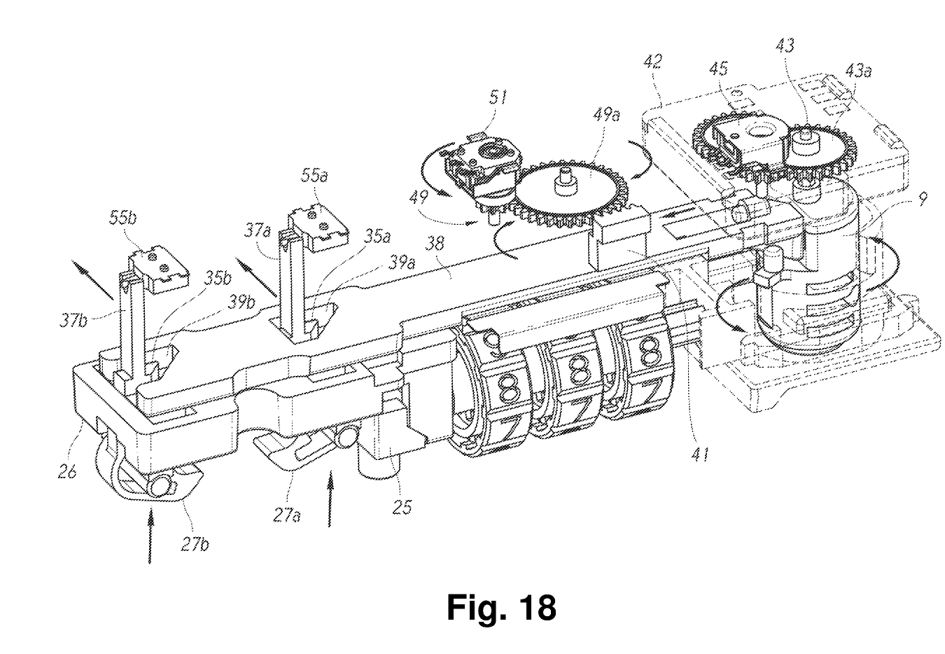

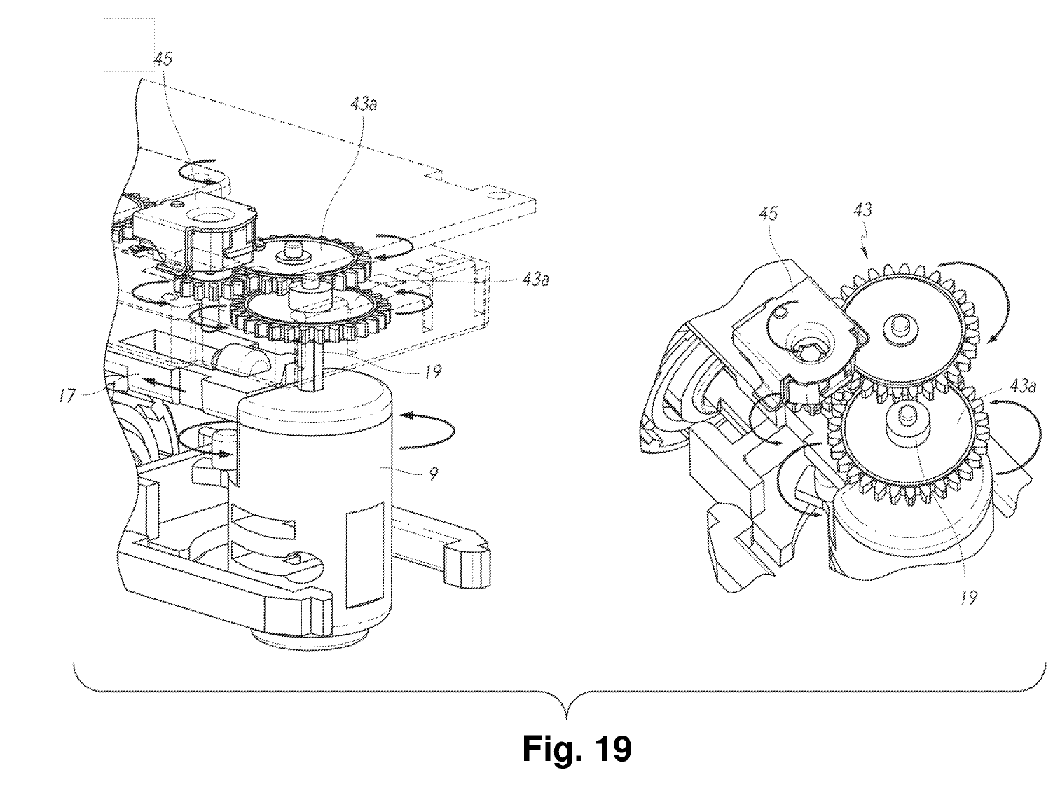

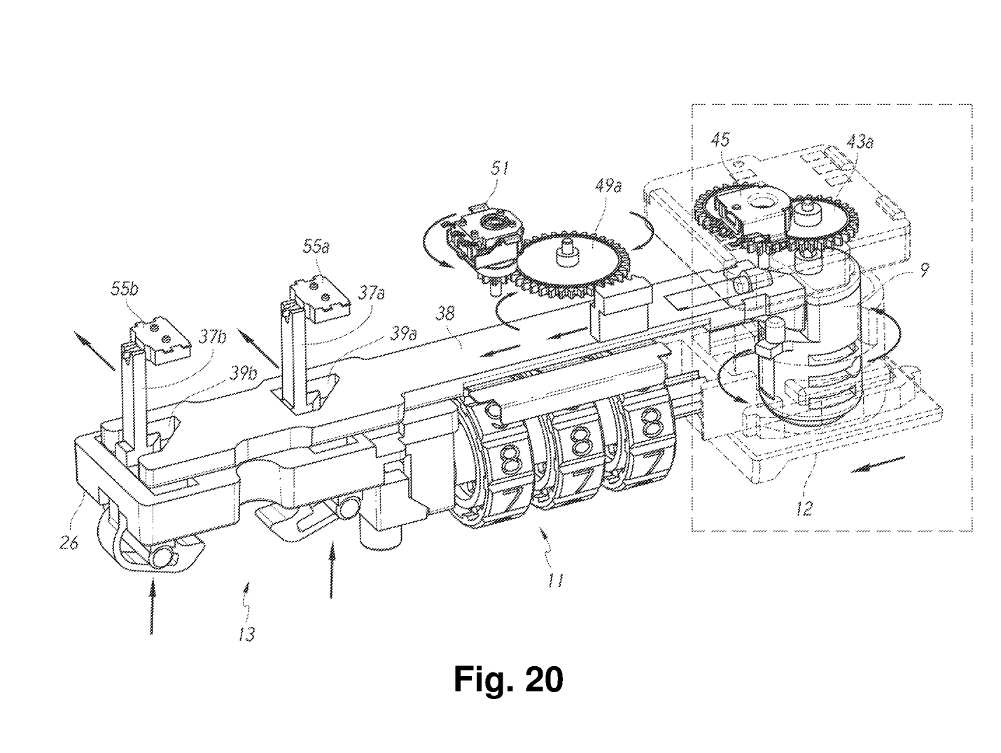

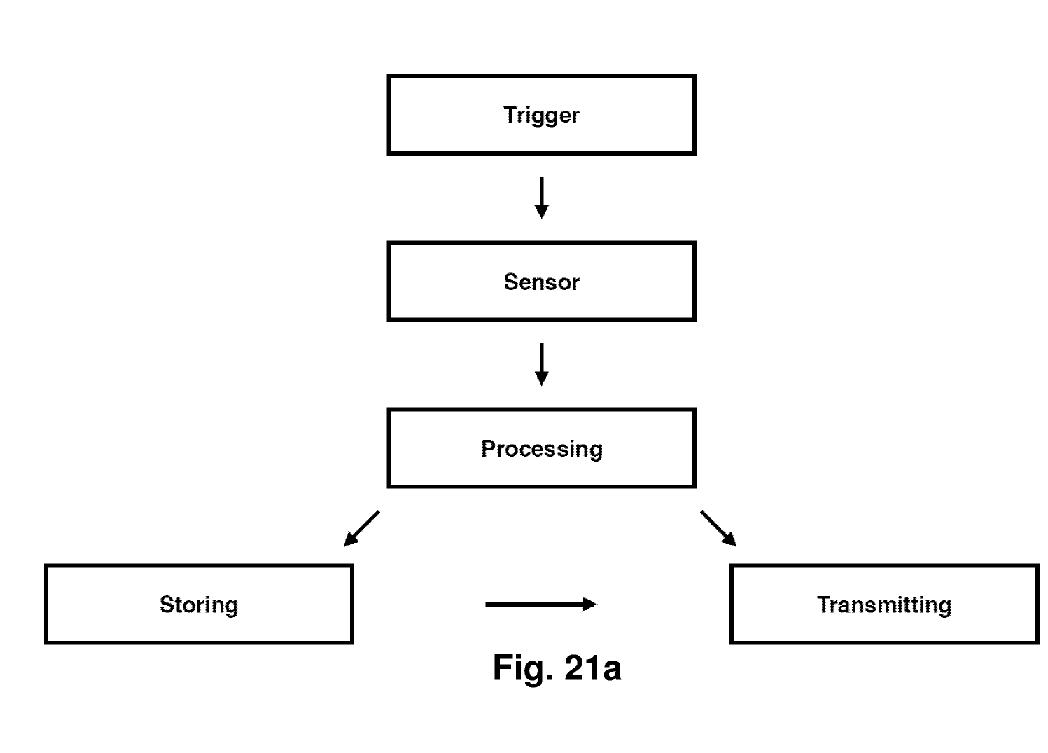

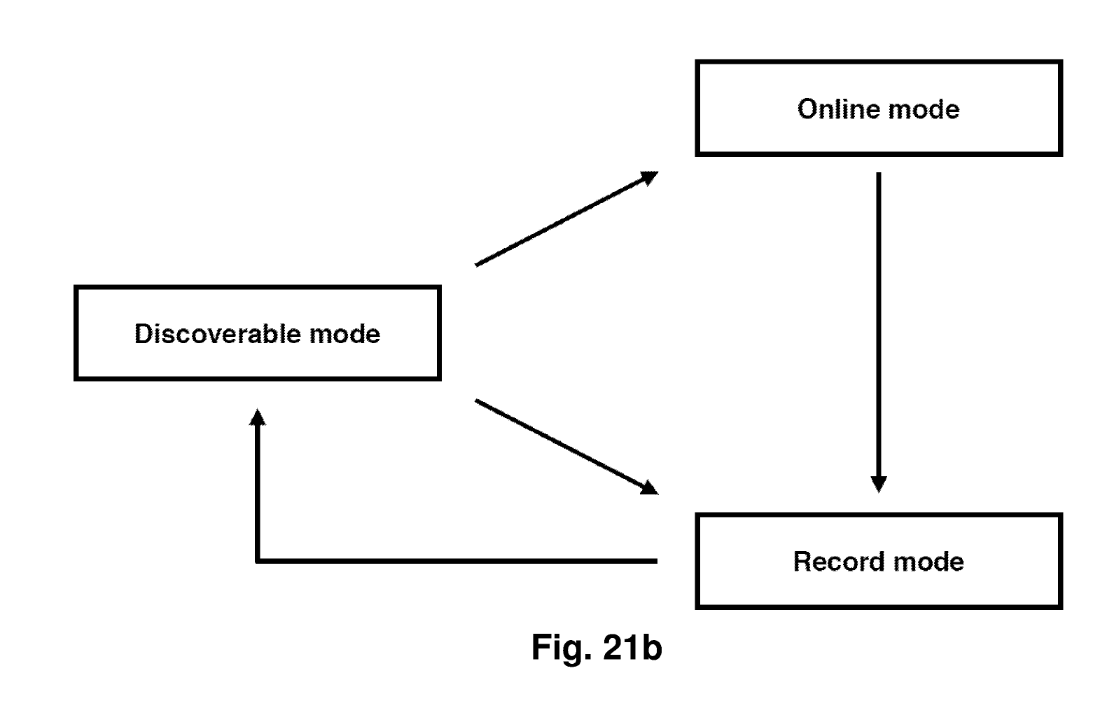

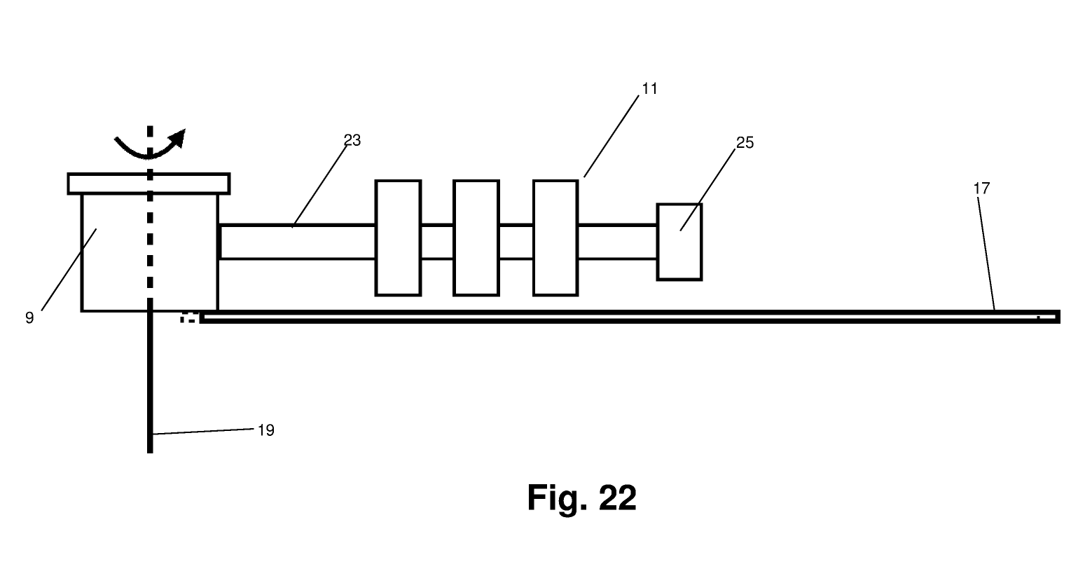

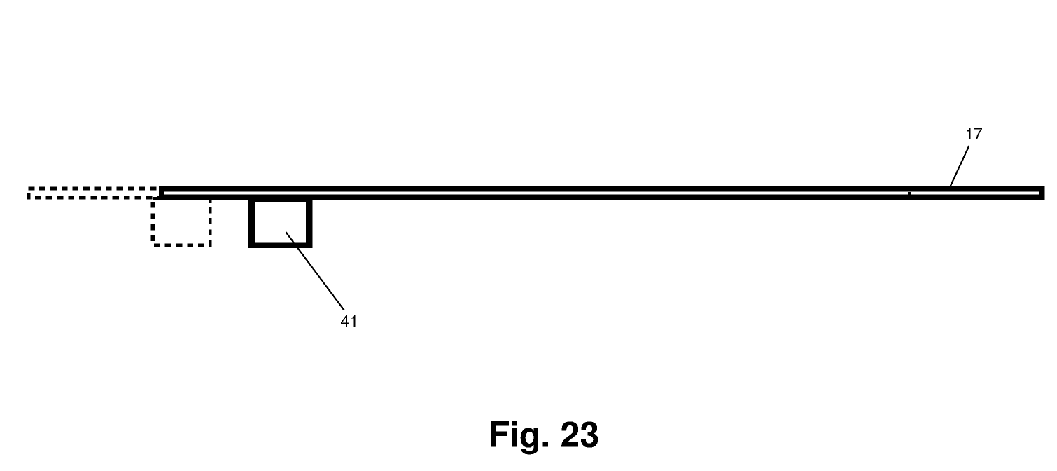

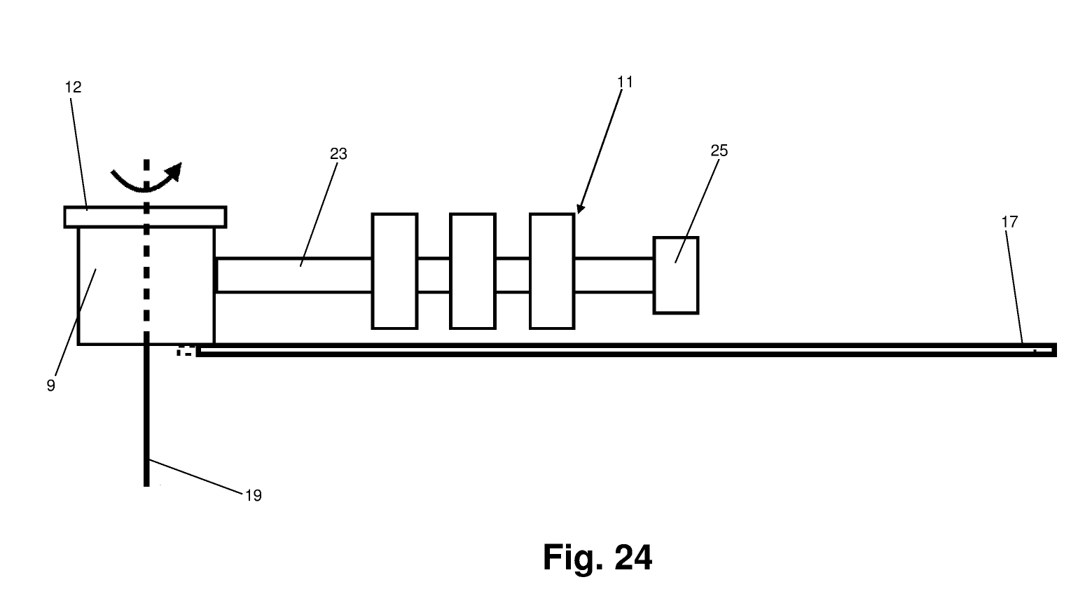

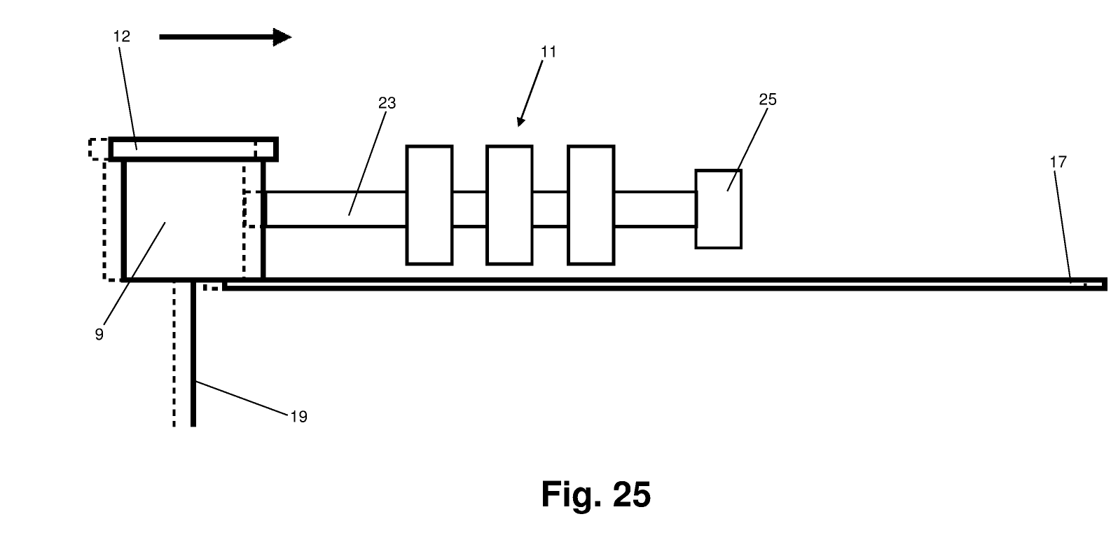

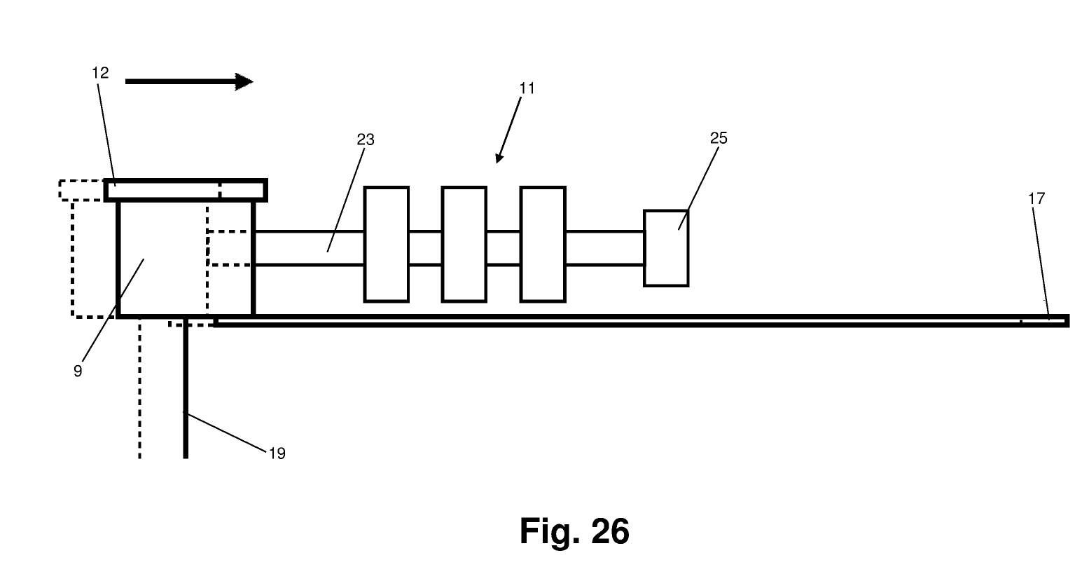

Referring to FIGS. 7 to 10, the zip retention means 13 comprises a mounting block 26 and a pair of zip retention latches 27a, 27b pivotally mounted to the housing 4 and arranged to extend toward two apertures 28a, 28b respectively formed in the outer sidewall of the housing 4. The mounting block 26 and latches 27a, 27b are fixed relative to the sliding plate 17 and axle 23 such that the sliding plate 17 is linearly moveable relative to the mounting block 26 and latches 27a, 27b.

The latches 27a, 27b are arranged to face one another and are pivotally mounted to the housing between a first position in which the zip retention means 13 is in a zipper retaining state and a second position in which the zip retention means 13 is in a zipper release state. A torsion spring is associated with each latch 27a, 27b and biases the latches 27a, 27b toward the zipper release state. A central column 29 extends between the two latches 27a, 27b and is arranged relative to the latches 27a, 27b such that, in the zipper release state, a gap is formed between the latches 27a, 27b and the column 29 via which a pair of zipper pull tabs may enter and exit the housing 4 through the two apertures 28a, 28b and such that, in the zipper retaining state, each zipper pull tab is retained relative to the housing 4 by virtue of a latch 27a, 27b extending through an eyelet of the pull tab.

With reference to FIGS. 11 to 14, the mounting block 26 comprises a pair of substantially parallel, spaced apart channels 30a, 30b formed in the body of the mounting block 26. A latch trigger 31a, 31b is slidably received in each channel 30a, 30b and linearly moveable within the channel 30a, 30b between first and second positions in a direction substantially perpendicular to the direction of movement of the sliding plate 17. Two apertures 33a, 33b are formed in the body of the mounting block 26 adjacent respective channels 30a, 30b such that part of each latch 27a, 27b can extend into respective channels 30a, 30b of the mounting block 26 via a corresponding aperture 33a, 33b.

Each trigger 31a, 31b comprises a groove 34a, 34b formed in a sidewall thereof which is arranged such that, in the first position, the corresponding aperture is closed off by the trigger 31a, 31b and in the second position, the groove 34a, 34b is aligned with the corresponding aperture 33a, 33b to form a recess into which the part of the corresponding latch 27a, 27b can extend. Each trigger 31a, 31b is spring biased toward the first position in which the aperture is closed off and the corresponding latch 27a, 27b cannot extend into the channel 30a, 30b of the mounting block 26. In this position, the latches 27a, 27b are held in the zipper retaining state.

Each latch 27a, 27b is biased by the torsion spring toward respective apertures 33a, 33b of the mounting block 26. Thus, when the triggers 31a, 31b are in the second position such that the grooves 34a, 34b are aligned with the apertures 33a, 33b, each latch 27a, 27b is urged into the channel 30a, 30b and held in place by the action of the torsion springs. In this position, the latches 27a, 27b are in a zipper release state and the triggers 31a, 31b are prevented from returning to the first position due to the presence of the part of each latch 27a, 27b extending into the channel.

Each trigger 31a, 31b further comprises an actuating portion 35a, 35b on the underside of the trigger 31a, 31b and a trigger pin 37a, 37b which extends from the actuating portion 35a, 35b substantially perpendicularly to the sliding plate 17. The actuating portion 35a, 35b and trigger pin 37a, 37b of each trigger 31a, 31b extend through corresponding apertures 39a, 39b formed in the sliding plate 17.

The actuating portion 35a, 35b and apertures 39a, 39b each comprise interfacing ramped surfaces which are arranged such that when the sliding plate 17 is moved in a direction toward the mounting block 26, the interfacing ramped surfaces of the actuating portion 35a, 35b and apertures 39a, 39b respectively urge the triggers 31a, 31b from the second position to the first position, thereby aligning the grooves 34a, 34b with respective apertures 33a, 33b and allowing the latches 37a, 37b to pivot into the corresponding channel 30a, 30b of the mounting block 26 and into the zipper release state. Thus, the triggers 31a, 31b hold the latches 27a, 27b in the zipper release state until the triggers 31a, 31b are moved to the second position by the sliding plate 17 thereby actuating the zip retention means 13 to switch from a zipper retaining state to a zipper release state.

When the zip retention means 13 is in a zipper release state and a zipper pull tab is inserted into each of the apertures 28a, 28b of the housing 4, the pull tabs act on the latches 37a, 37b causing them to pivot against their spring biasing out from the mounting block 26 toward a zipper retaining state. When the latches 27a, 27b are moved out from the mounting block 26, the triggers 31a, 31b are urged from the second position to the first position by spring biasing thereby closing off the apertures of the mounting block 26 and preventing the latches 27a, 27b from pivoting back to the zipper release state. Movement of the triggers 31a, 31b from the second position to the first position by insertion of the zipper pull tabs therefore arises independently of movement of the sliding plate 17. Likewise, movement of the triggers 31a, 31b from the second position to the first position by forcefully pulling the zipper pull tabs out from the latches may arise independently of movement of the sliding plate 17. Such movements may be detected by the detecting part 7 as further described below.

Referring to FIGS. 8 to 10 and FIGS. 15 and 16, a linear actuator 41 extends from the underside of the sliding plate 17. The linear actuator 41, trigger pins 37a, 37b and rod extension 19 are provided for engagement and interaction with corresponding detecting arrangements on the detecting part 7 to determine when and how a tampering or unlocking event occurs. Thus, the linear actuator 41, trigger pins 37a, 37b and rod extension 19 are linkages that link the moveable parts of the locking part 5 to the detecting part 7. In the embodiment depicted, the rod extension 19, triggers pins 37a, 37b and linear actuator 41 are formed integrally with the tumbler lock 9, zip retention means 13 and sliding plate 17, respectively. Alternatively, it is envisaged that the rod extension 19, trigger pins 37a, 37b and/or linear actuator 41 could be manufactured separately and retrofit to the tumbler lock 9, zip retention means 13 and sliding plate 17, respectively.

Whilst the linear actuator 41, trigger pins 37a, 37b and rod extension 19 are configured to mechanically engage with elements of the detecting part 7, it is envisaged that, additionally or alternatively, the locking part 5 and the detecting part 7 could be linked by a non-mechanical means such as one or more lasers from one or more laser sensors.

The mechanism of the locking part 5 may be housed within a self-contained unit such that one or more sidewalls separates the mechanism of the locking part 5 from the detecting part 7. In such an arrangement, a sidewall of a housing of the locking part 5 may comprise one or more apertures through which the rod extension 19, trigger pins 37a, 37b and linear actuator 41 may extend to enable interaction between the mechanism of the locking part 5 and the detecting part 7 and linear movement relative to the housing.

In the embodiment depicted, the detecting part 7 is manufactured separately from the locking part 5 and arranged to engage with the linear actuator 41, trigger pins 37a, 37b and rod extension 19 of the locking part 5 upon assembly of the locking apparatus 3. The detecting part 7 comprises a first printed circuit board (PCB) 38 which supports a plurality of detector arrangements 39, 47, 53 and electronic components for logging and transmission of detection events.

A first detector arrangement 39 is configured to engage with the rod 19 extending from the pin tumbler lock 9. The first detector arrangement 39 comprises a gear box 42 comprising a first gear train 43. The first gear train 43 comprises a plurality of gears each having differing numbers of teeth which are arranged to increase the number of rotations of the cogs in the train series and, hence, magnify rotational movement of the rod extension 19.

The rod 19 extends into the gear box 42 via an aperture in the gear box housing and engages with the centre of one gear 43a of the first gear train 43, effectively forming an axle for the gear 43a. The rod 19 has a hexagonal cross-section and extends into a correspondingly shaped aperture at the centre of the gear 43a such that the gear 43a rotates with the rod 19. Thus, when the key cylinder is rotated by a key or other item, the rod 19 and first gear 43a also rotate and drive the first gear train 43. The first gear train 43 is arranged to provide a 6:1 gear ratio to magnify the rotational movement and make it easier to distinguish between small rotations (indicating a possible tampering event) and larger rotations (indicating an unlocking event).

The gear box 42 is slidably mounted to the first PCB 38 and linearly moveable with the pin tumbler lock 9 due to engagement of the rod extension 19 with the gear box 42. A second PCB 44 is arranged within the gear box 42 housing together with a rotary encoder 45 which is mounted to the second PCB 44. The second PCB 44 and encoder 45 are powered through a sliding contact with contact pins of a modular contact 46 mounted to the first PCB 38. The second PCB 44 and encoder 45 are arranged and configured to detect rotation of the first gear train 43 and, indirectly, detect rotation of the key cylinder and transmit a detection signal via the modular contact 46 to a microcontroller unit (MCU) 56 provided on the first PCB 38.

Whilst the first detector arrangement comprises a rotary encoder 45 for detecting rotational movement, it is envisaged that a detector could be included to detect the linear movement of the gear box 42.

A second detector arrangement 47 comprises a second gear train 49 comprising a plurality of gears which are rotatably supported on the first PCB 38. The teeth of one gear 49a of the second gear train 49 meshes with the teeth of the linear actuator 41 extending from the slide bar 17. Thus, linear movement of the slide bar 17 imparts rotational movement into the gear 49a via the linear actuator 41 which drives the second gear train 49. The second gear train 49 is configured to provide a gear ratio of 4:1 to magnify the movement of the sliding plate 17. The second gear train 49 is associated with a second rotary encoder 51 which is arranged to detect rotational movement of the second gear train 49 and transmit a detection signal to the MCU 56.

A third detector arrangement 53 comprises a pair of two-way leaf switches 55a, 55b which are arranged to interact with the trigger pins 37a, 37b. Each leaf switch 55a, 55b comprises a moveable arm or switch which is arranged such that movement of the arm in a specific direction activates the switch 55a, 55b and generates a signal. An end of each trigger pin 37a, 37b comprises a recess 40a, 40b which extends around the arm of each leaf switch 55a, 55b. The recess 40a, 40b of each trigger pin is arranged to urge the arm in an activating direction upon lateral movement of the trigger pin 37a, 37 by linear movement of the sliding plate 17.

Whilst the drawings depict the first PCB 38 arranged on the opposite side respectively of the first second and third detector arrangements 39, 47, 53 from the locking part 5, it is envisaged that the first PCB 38 could be arranged between the locking part 5 and at least parts of the first, second and third sensor arrangements 39, 47, 53. Arranging the PCB 38 in this way may advantageously enable a more compact locking apparatus 3 to be constructed. In this alternative embodiment, the first PCB 38 may comprise one or more apertures through which one or more of the rod 19, linear actuator 41 and trigger pins 39a, 39b may extend to engage with the first, second and/or third sensor arrangements 39, 47, 53 and move relative to the first PCB 38.

The second and third detector arrangements 47, 53 are fixed such that the sliding plate 17 moves linearly relative to the second and third detector arrangements 47, 53. This ensures relative movement between the linear actuator 41 and the second detector arrangement 47 so that the linear actuator 41 drives the second gear train 49. It also ensures the positioning of the trigger pins 37a, 37b relative to the leaf switches 55a, 55b is maintained so that lateral movement of the trigger pins 37a, 37b pushes the arm of each leaf switch 55a, 55b respectively.

Referring to FIG. 17, the MCU 56 mounted on the first PCB 38 comprises memory, a memory controller and one or more processor cores. Additional electronic components are connected to the first PCB 38 including the first 45 and second 51 encoders, an accelerometer and a gyroscope sensor 57, a dual coloured light emitting diode 58 for indicating the status of the locking apparatus 3, a rubber reset key 59 provided to reset the detecting part 7 when desired and radio frequency circuitry 61 for transmission and receipt of wireless signals. The electronic components communicate over one or more communication buses and are powered by a power system which comprises two dry cell AAA batteries 60a, 60b which may be accessed from the rear of the housing 4 for replacing the batteries when necessary. Other suitable batteries or power sources will be apparent to those skilled in the art.

The memory comprises a non-volatile solid state memory with read/write capabilities. Access to the memory by other components of the device such as the encoders is controlled by the memory controller. The radio frequency circuitry 61 comprises a radio frequency transceiver and is operable to convert electrical signals into electromagnetic waves and vice versa so that the locking apparatus 3 can transmit and receive wireless signals to and from remote communication devices such as smartphones, other luggage tracking/monitoring communication devices, computers, computer networks or other programmable apparatus. The radio frequency circuitry 61 is configured to communicate wirelessly using any of a plurality of communication standards, protocols and technologies such as Global System for Mobile Communications (GSM), Bluetooth, Bluetooth Low Energy, Wireless Fidelity (Wi-Fi), ZigBee or any other suitable communication protocol.

The MCU 56 runs one or more software programs stored in the memory to perform functions for the luggage apparatus 3 and to process data. The software programs comprise a communication module, a status module and a detection module. The communication module includes a set of instructions for generating signals for transmission to other electronic communication devices and for handling data received by the RF circuitry 61.

The status module is operable to process data from the accelerometer and the gyroscope sensor to switch the locking apparatus 3 between different states. The locking apparatus 3 is operable between several different states which include airplane mode, deep sleep mode, online mode, record mode, discoverable mode and offline mode. The status module is configured to automatically switch between the different modes to provide a seamless user experience and efficiently manage power consumption whilst ensuring compliance with travel regulations and standards.

The status module is configured to switch the locking apparatus 3 to airplane mode when an acceleration or deceleration profile along a particular inclined or inclining path or a declined or declining path is detected which corresponds to the acceleration or deceleration profile of an aircraft during take-off and landing, both for safety purposes and for power saving.

The status module is also configured to switch the locking apparatus 3 to deep sleep mode after a predetermined amount of time in which no movement is detected. The purpose of deep sleep mode is to significantly reduce the power consumption of the locking apparatus 3, for example, during a flight.

The status module is configured to switch the locking apparatus 3 to online mode when the locking apparatus is connected to a remote device such as a smartphone via Bluetooth or other wireless communication protocol. In online mode, the locking apparatus 3 is fully functional such that the detector arrangements 39, 47, 53 are energised for detection purposes and the locking apparatus 3 is transmitting locking apparatus 3 status information in real-time to the remotely connected device.

The status module is configured to switch the locking apparatus 3 to record mode when the locking apparatus 3 is not connected to a remote device but movement of the luggage is detected by the accelerometer and/or gyroscope sensor. In record mode, the locking first, second and third detector arrangements are energised so as to detect unlocking or tampering events and the apparatus 3 is configured to store any detected unlocking/tampering events in memory and to intermittently scan for smart devices/systems to pair with via Bluetooth.

The status module is configured to switch to discoverable mode when the locking apparatus 3 is active, as detected by the luggage movement, but has not been paired with any smart device or smart system. Thus, in discoverable mode, the locking apparatus 3 is energised and may be paired with a new or additional smart system for transmission of status information and alerts.

The luggage apparatus 3 offline mode is for when the luggage apparatus 3 is in an inactive pre-purchase state. The locking apparatus 3 comprises a mechanical switch (not shown) to activate the locking apparatus 3 and enter into discoverable mode from offline mode.

Whilst a combination of accelerometer(s), gyroscopic sensor(s) and remote device connectivity may be used to determine which operational mode the locking apparatus 3 should be in, it is envisaged that other status determining methods could be adopted and implemented. For example, it is envisaged that the locking apparatus 3 will use wireless signals within an airport as well as the automatic dependent surveillance-broadcast (ADS-B) signal transmitted by the aircraft to determine the environment in which the luggage is located at particular times and also to determine when to switch between airplane mode, deep sleep mode, online or record mode and other operational modes.

In such an implementation, the locking apparatus RF circuitry 61 could be used to detect common airport and airplane radio frequency signal strengths to determine whether the locking apparatus 3 and, hence, the luggage article 1 is on a plane. By utilising the ADS-B transponder signal, the locking apparatus 3 can determine when it is on the plane and when to enter airplane mode.

In addition to determining the location of the locking apparatus 3, the ADS-B signal may also be used to store information regarding the plane on which the locking apparatus 3 is stowed. The locking apparatus 3 may store the flight information provided by the ADS-B signal in memory and transmit this information to remote smartphones and systems. This will enable smartphones and smart systems to determine which luggage article 1 is stowed on which airplane and track the luggage article 1 from airport to airport.

The detection module includes various software components for processing one or more signals received from the first 45 and second 51 encoders and the leaf switches 55a, 55b, determining which encoder 45, 51 or switch 55a, 55b transmitted a detection signal, the length of the detection event and the time of the detection signal. The detection module further includes various software components for comparing the signal(s) with existing detection profiles stored in memory to determine which type of detection event has occurred. For example, a pin tumbler lock unlocking event signal may comprise a continuous signal from the first encoder 45 whose duration is synonymous with a complete turning of a key from the locked state to the unlocked state.

In use, the locking apparatus 3 is incorporated into the body of an item of luggage 1 such that the longitudinal axis of the housing 4 is substantially aligned with a straight section of zipper track of the luggage 3. Therefore, the sliding plate 17, combination wheel axle 23 and zip latches 27a, 27b are linearly or pivotally moveable along a plane which is substantially parallel to the zipper track. Thus, where the zipper of the luggage article 1 comprises two zipper sliders with corresponding pull tabs, the two pull tabs may be arranged to extend from the zipper track into the two apertures 28a, 28b of the housing 4 for engagement with the two latches 27a, 27b as described above.

The locking apparatus 3 is operable to communicate with a remote electronic communication device such as a smartphone via the RF circuitry 61. The smartphone may comprise a software application stored in memory which is operable to communicate with the locking apparatus 3 and obtain status information from the locking apparatus 3.

When in an online state, the locking apparatus 3 transmits status information to the smartphone in real time via Bluetooth. The status information comprises the last recorded locking status i.e. “locked” or “unlocked” as detected by the detecting part 7, and details of any previous unlocking or tampering events detected by the detecting part 7. Each detected event is associated with a time stamp to indicate when the event took place. Furthermore, each detected event is associated with a particular detector arrangement to distinguish between an unlocking event triggered by the pin tumbler lock 9, combination lock 11 and zip retention means 13, respectively. Thus, the locking apparatus 3 is capable of determining whether it has been unlocked by the pin tumbler lock 9, perhaps using a TSA master key, or by the combination lock by an unauthorised third party or by the zip retention means, for example, by wrenching of the pull tabs from the zip retention means 13 by force.

The software application also permits a user to query the locking apparatus 3 to determine status information. For example, if a user wishes to determine the locking status of an item of luggage, the user may instruct the software application to wirelessly transmit an interrogation message from the smartphone to the locking apparatus. The RF circuitry of the locking apparatus 3 receives the message for processing by the processing module and transmits a response message with status information. In addition, the processing module is configured to transmit status information to the user immediately upon detection of an unlocking or tampering event so that the user is alerted to the event and can act accordingly.

The software application also permits a user to set the status of the locking apparatus 3 as locked so that the user can indicate to the application when the pull tabs are seated in the zip retention means 13 and the locking apparatus 3 is physically in a locked configuration. Setting the locking apparatus 3 to a locked condition on the software application effectively starts the locking apparatus 3 monitoring and transmitting detected unlocking and tampering events to the smartphone.

With reference to FIGS. 18 to 20, the locking apparatus 3 detects movement of one or more of the pin tumbler lock 9, combination lock axle 23 and zip retention means 13 via movement of the extension rod 19, linear actuator 41 and trigger pins 37a, 37b, respectively. Upon movement of one or more of the monitored, moveable components of the locking part 5, the corresponding encoder 45, 51, or leaf switches 55a, 55b transmits a detection signal to the MCU 56 for processing. The detection module identifies which encoder 45, 51, or switch 55a, 55b transmitted the signal, records the time of the signal and conducts a comparison of the signal with stored profiles to determine the type of event e.g. tampering event, key unlocking event, forced pull tabs event.

With reference to FIGS. 21a and 21b, upon detection of a tampering or unlocking event by the first 45 and/or second encoders 51, and/or the leaf switches 55a, 55b, if the locking apparatus 3 is in online mode, the communication module attempts to transmit a notification signal to a user's smartphone or other device via the RF circuitry 61. If pairing and communication with a remote device cannot be established, the locking apparatus 3 enters record mode in which the detection module stores the detection event in memory for later transmission. Unless in sleep mode or airplane mode, the locking apparatus 3 will periodically enter into discoverable mode in an attempt to pair with a remote device. If the locking apparatus 3 successfully pairs with a remote device, the locking apparatus 3 enters into online mode and transmits status information and information relating to any detected tampering or unlocking event.

With reference to FIGS. 22 and 23, in the example of a genuine key unlocking event, rotation of the pin tumbler lock 9 by the key rotates the extension rod 19 which drives the first gear train 43 and urges the sliding plate 17 linearly toward the zip retention means 13. Rotation of the first gear train 43 is detected by the first encoder which transmits a first detection signal to the MCU. Linear movement of the sliding plate 17 and, hence, the linear actuator 41 drives the second gear train 49 whose rotational movement is detected by the second encoder. Upon detection of rotation of the second gear train, the second encoder 51 transmits a second detection signal to the MCU for processing.

A complete linear movement of the sliding plate toward the zip retention means 13 brings the ramped surfaces of the sliding plate apertures 39a, 39b into engagement with the corresponding ramped surfaces of the triggers 31a, 31b, thereby causing the triggers 31a, 31b to move laterally with respect to the sliding plate 17. Lateral movement of the triggers 31a, 31b permits the zip latches 27a, 27b to pivot into a pull tab release state and also causes the trigger pins 37a, 37b to activate the leaf switches 55a, 55b. Activation of the leaf switches causes the leaf switches to transmit a third detection signal to the MCU 56 for processing.

Upon receipt of the first, second and third detection signals, the detection module compares the detection signal with stored profiles to determine the type of event, associates the detection event with a timestamp and the identity of the encoder that transmitted the signal. The communication module then attempts to transmit the determined event to a remote device via the RF circuitry. If no remote device is within communication range or if the locking apparatus 3 is in a sleep state without wireless transmission of signals, the detection module stores information relating to the detection even in memory. When the locking apparatus 3 is able to establish communication with a remote communication device such as a user's smartphone, the locking apparatus 3 transmits data relating to the detection event to the smartphone for processing to alert the user.

With reference to FIGS. 24 and 25, in the example of an attempted unauthorised key unlocking event, perhaps with a hair pin or other tampering device, minor rotations of the rod extension 19 and minor linear movements of the sliding plate 17 will be magnified by the corresponding gear trains 43, 49 and therefore detected by the first 45 and second 51 encoders as a series of smaller rotations of the first and second gear trains 43, 49. The first and second detection signals transmitted by the first and second encoders 45, 51 respectively will match a stored profile of a tampering event when processed by the detection module.

With reference to FIGS. 23 and 26, in the example of a combination lock 11 unlocking event, the first gear train 43 will not be driven due to absence of rotation of the pin tumbler lock 9. Instead, the sliding plate 17 will be driven by pushing the pin tumbler lock 9 in a direction toward the zip retention means 13. Linear movement of the sliding plate 17 and the linear actuator 41 drives the second gear train 49 which is detected by the second encoder 51 and transmitted to the MCU 56 for processing. The linear movement of the sliding plate 17 will also move the trigger pins 37a, 37b laterally with respect to the leaf switches 55a, 55b thereby generating a third detection signal which is also transmitted to the MCU 56 for processing. The detection module compares the detection signals with stored profiles and determines that the unlocking event corresponds to a combination lock unlocking event.

When one or more zipper pull tabs are inserted into corresponding apertures 28a, 28b of the locking apparatus 4, the trigger pins 37a, 37b are moved thereby actuating the leaf switches 55a, 55b and generating a signal which is transmitted to the MCU 56 for processing. Thus, the locking apparatus 3 is capable of detecting when zipper pull tabs are inserted into the locking apparatus 3.

In the example of a forced removal of zipper pull tabs from the zip retention means 13, the latches 27a, 27b pivot and urge the triggers 31a, 31b and, hence, trigger pins 37a, 37b to move relative to the leaf switches 55a, 55b thereby generating a detection signal which is transmitted to the MCU 56 for processing. The detection module compares the detection signal to known profiles to determine that a forced pull tab event has occurred.

The ability to monitor movements of the various components of the locking part and compare those movements with known movements that correspond to different types of unlocking and tampering events, enables the locking apparatus 3 to distinguish between many different types of unlocking and tampering events and to alert a user accordingly.

The above embodiment is described by way of example only. Many variations are possible without departing from the scope of the invention as defined in the appended claims.

1. A locking apparatus for securing a luggage article comprising:
a mechanism for unlocking the locking apparatus including at least one moveable member moveable in an unlocking operation,
at least one detector arrangement associated with at least one moveable member by at least one linkage between the detector arrangement and the moveable member such that at least one linkage triggers the detector arrangement upon movement of the moveable member.

2. A locking apparatus as claimed in claim 1, wherein at least part of at least one linkage replicates movement or moves with the moveable member.

3. (canceled)

4. (canceled)

5. A locking apparatus as claimed in claim 1, wherein at least one linkage mechanically connects a detector arrangement and a moveable member.

6. A locking apparatus as claimed in claim 1, wherein at least one linkage is integrally formed with at least one moveable member.

7. (canceled)

8. A locking apparatus as claimed in claim 1, wherein a first moveable member is rotatable by a key and rotation of the first moveable member rotates at least one linkage to trigger at least one detector arrangement.

9. A locking apparatus as claimed in claim 8, wherein a second moveable member is moveable by the first moveable member for unlocking the locking apparatus, and at least one linkage moves with the second moveable member to trigger at least one detector arrangement.

10. A locking apparatus as claimed in claim 8, further comprising a combination lock restricting movement of the first moveable member in an engaged state and permitting movement of the first moveable member in a disengaged state.

11. A locking apparatus as claimed in claim 1, wherein at least one moveable member comprises a retention part operable between a closed state and an open state, wherein in the closed state an external object may be retained by the retention part relative to the locking apparatus and in the open state an external object is releasable from the locking apparatus.

12. (canceled)

13. (canceled)

14. A locking apparatus as claimed in claim 11, wherein a linkage extends between at least part of the retention part and at least one detector arrangement such that movement of at least part of the retention part moves the at least one linkage to trigger the detector arrangement.

15. A locking apparatus as claimed in claim 1, wherein at least one detector arrangement comprises one or more gears arranged to amplify movement of one or more moveable members.

16. A locking apparatus as claimed in claim 1, wherein at least one detector arrangement comprises one or more sensors actuable by one or more linkages.

17. (canceled)

18. A detecting part of a locking apparatus comprising one or more detector arrangements configured to monitor movement one or more moveable members of an unlocking mechanism of a locking part of the locking apparatus between a locked state and an unlocked state of the locking apparatus.

19. A detecting part as claimed in claim 18, engageable with one or more linkages extending from the locking part.

20. A detecting part as claimed in claim 18, wherein at least one detector arrangement comprises a gear train driven by movement of one or more of the moveable members of the locking apparatus to amplify movement of the one or more moveable members.

21. A detecting part as claimed in claim 18, wherein at least one detector arrangement comprises a sensor switch actuated by movement of one or more of the moveable members of the locking apparatus.

22. A locking part of a locking apparatus, the locking part comprising:
an unlocking mechanism comprising at least one moveable member moveable in an unlocking operation,
at least one linkage moveable with at least one moveable member,
wherein at least one linkage is engageable with one or more detector arrangements for detecting movement of one or more moveable members.

23. (canceled)

24. (canceled)

25. (canceled)

26. (canceled)

27. (canceled)
